(19) United States
(12) Patent Application Publication
(10) Pub. No.: US 2026/0149570 A1
(43) Pub. Date: May 28, 2026

(54) System and Method for Pre-Authentication Encryption

(71) Applicant: Zebra Technologies Corporation, Lincolnshire, IL (US)

(72) Inventor: Anandakumar Gopalsamy, Ronkonkoma, NY (US)

(73) Assignee: Zebra Technologies Corporation, Lincolnshire, IL (US)

(21) Appl. No.: 18/959,279

(22) Filed: Nov. 25, 2024

(51) Int. Cl. H04L 9/08

(52) U.S. Cl. CPC H04L 9/0825

(57) ABSTRACT

An example method includes: selecting an access point to connect to; obtaining a public key of the access point; generating a temporary key for pre-authentication encryption; encrypting the temporary key with the public key of the access point; sending an authentication request to the access point to initiate an authentication process with the access point, the authentication request including the encrypted temporary key; completing the authentication process to begin authenticated communications with the access point; and discarding the temporary key.

### BACKGROUND

In Wi-Fi, denial of service (DOS) attacks are staged by malicious devices impersonating access points and sending disconnection notifications, such as deauthentication messages or disassociation messages, which results in client or endpoint devices getting disconnected from the network. DOS attacks can be mitigated after authentication between the client device and the access point, when the client can verify the access point as the source of the disconnection notifications. However, between initiation of a new connection and completion of the authentication process, the client device is still vulnerable to DOS attacks.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a schematic diagram of a system for pre-authentication encryption.

FIG. 2 is a block diagram of certain internal hardware components of the device and access point of FIG. 1.

FIG. 3 is a flowchart of an example method of pre-authentication encryption.

FIG. 4 is a schematic diagram of an example performance of pre-authentication encryption.

FIG. 5 is a flowchart of an example method of sending a disconnection notification at an access point.

FIG. 6 is a flowchart of an example method of handling a disconnection notification at a computing device.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method comprising: selecting an access point to connect to; obtaining a public key of the access point; generating a temporary key for pre-authentication encryption; encrypting the temporary key with the public key of the access point; sending an authentication request to the access point to initiate an authentication process with the access point, the authentication request including the encrypted temporary key; completing the authentication process to begin authenticated communications with the access point; and discarding the temporary key.

Additional examples disclosed herein are directed to another method, at an access point, the method comprising: obtaining a public key and a private key corresponding to the public key for the access point; receiving an authentication request from an computing device to initiate an authentication process, the authentication request including an encrypted temporary key for pre-authentication encryption; decrypting and storing the temporary key using the private key; completing the authentication process to begin authenticated communications with the computing device; and discarding the temporary key.

Further examples disclosed herein are directed to a device comprising: a communications interface; a controller interconnected with the communications interface, the controller configured to: select an access point to connect to; obtain a public key of the access point; generate a temporary key for pre-authentication encryption; encrypt the temporary key with the public key of the access point; send an authentication request to the access point to initiate an authentication process with the access point, the authentication request including the encrypted temporary key; complete the authentication process to begin authenticated communications with the access point; and discard the temporary key.

Further examples disclosed herein are directed to an access point comprising: a communications interface; and a processor interconnected with the communications interface, the processor configured to: obtain a public key and a private key corresponding to the public key for the access point; receive an authentication request from a computing device to initiate an authentication process, the authentication request including an encrypted temporary key for pre-authentication encryption; decrypt and store the temporary key using the private key; complete the authentication process to begin authenticated communications with the computing device; and discard the temporary key.

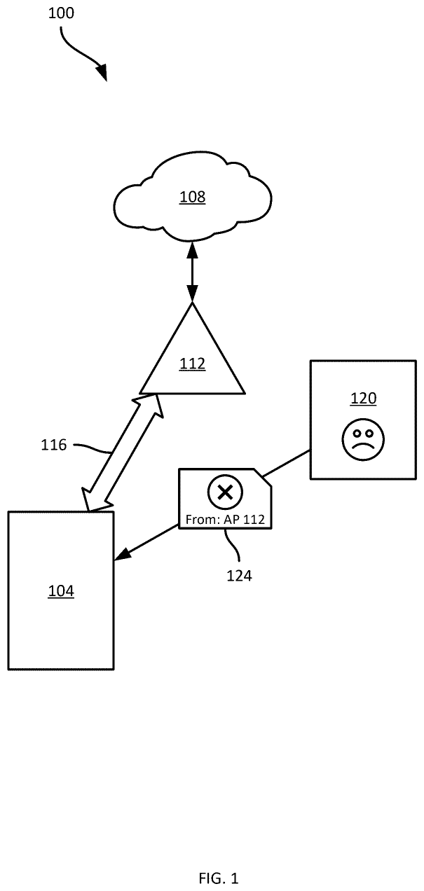

FIG. 1 depicts a system 100 for pre-authentication encryption in accordance with the teachings of this disclosure. The system 100 includes a computing device 104 (also referred to herein as the endpoint device 104 or simply the device 104) configured for wireless communications. The device 104 may be a mobile computing device, such as a handheld computer, a mobile phone, a tablet, a barcode scanner or the like, or a fixed computing device, such as a desktop computer, kiosk, server, or the like.

In particular, the computing device 104 may be configured to connect to a network 108, which may be a wireless local area network (WLAN), such as one implemented according to the IEEE (Institute of Electrical and Electronics Engineers) 802.11 standard. In the present example, the network 108 is deployed by a set of access points, of which one access point 112 is illustrated. In particular, the device 104 may select the access point 112 to which to connect to access the network 108, for example based on proximity to the access point 112, signal strength with respect to the access point 112, or the like.

To connect to the access point 112, the computing device 104 may initiate an authentication process to establish an authenticated link 116 between the access point 112 and the computing device 104. In particular, the authenticated link 116 may allow for secure communications between the access point 112 and the computing device 104, for example employing one or more encryption methods such as pre-shared key (PSK) encryption, or according to industry standards, such as the IEEE 802.11w standard or the like.

To establish the authenticated link 116, the computing device 104 initiates the authentication process by sending an authentication request to the access point 112. The access point 112 may additionally send an authentication response to the computing device 104. The computing device 104 and the access point 112 may then follow a standard authentication process to install the keys in accordance with PSK encryption standards, or other suitable encryption protocols. Subsequent to the authentication process, the computing device 104 and the access point 112 may exchange messages securely by allowing verification of the source of the received messages.

In particular, upon authentication, the computing device 104 may be secure against denial of service (DOS) attacks. In a DOS attack, a malicious entity 120 may send disconnection notifications 124, such as a deauthentication message or a disassociation message, while mimicking the access point 112 as the source of such notifications. Without the authentication to verify the source of the message (e.g., according to encryption procedures such as those specified in the 802.11w standard), the computing device 104 may presume the disconnection notification is valid and may disconnect from the access point 112. The malicious entity 120 may continue to send disconnection notifications 124, thereby denying service to the computing device 104. With authentication, the malicious entity 120 will not be able to generate a suitable disconnection notification that is validated by the computing device 104 as being sent from the access point 112, and hence this type of attack may be thwarted.

However, messages exchanged during the authentication stage, such as the initial authentication request and authentication response messages, are still vulnerable to DOS attacks. In accordance with the present disclosure, the access point 112 may generate a public and private key pair and publishes the public key. For example, the access point 112 may provide the public key to the computing device 104 in response to a probe request by the computing device 104. The computing device 104 may then generate a temporary key for pre-authentication encryption and use the public key of the access point 112 to encrypt the temporary key. The computing device 104 may then send the encrypted temporary key to the access point 112 in an authentication request.

The temporary key may be used by the access point 112 to encrypt disconnection notifications prior to completing the authentication process. In particular, since the temporary key is encrypted using the public key of the access point 112, the temporary key may be decrypted using the private key of the access point 112, but may not be decrypted by the malicious device 120. Accordingly, when the computing device 104 subsequently receives a disconnection notification prior to completion of the authentication process with the access point 112, the device 104 may validate the source of the disconnection notification using the temporary key, as will be described further herein. The device 104 may therefore be protected from DOS attacks prior to authentication by employing the pre-authentication encryption described herein.

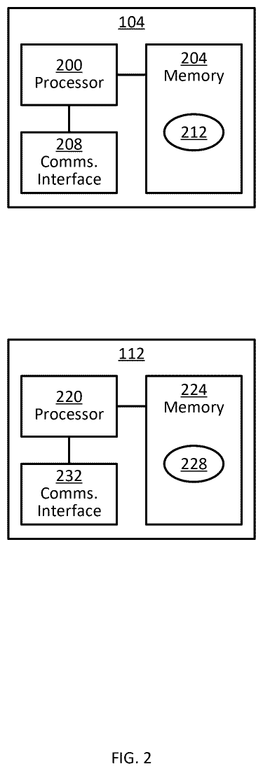

Turning now to FIG. 2, certain internal components of the computing device 104 and the access point 112 are illustrated. The device 104 includes a processor 200 such as a central processing unit (CPU), graphics processing unit (GPU), microcontroller, series of cooperating processors, application-specific integrated circuit (ASIC), or the like, interconnected with a non-transitory computer-readable storage medium, such as a memory 204. The memory 204 includes a combination of volatile memory (e.g., random access memory or RAM) and non-volatile memory (e.g., read only memory or ROM, electrically erasable programmable read only memory or EEPROM, flash memory). The processor 200 and the memory 204 may each comprise one or more integrated circuits. The memory 204 stores computer-readable instructions for execution by the processor 200, including one or more applications which, when executed, configure the processor 200 to perform the various functions of the device 104.

The device 104 further includes a communications interface 208 enabling the device 104 to exchange data with other computing devices, such as the access point 112. The communications interface 208 is interconnected with the processor 200. The communications interface 208 may further include a dedicated controller 212 and one or more antennas, transmitters, receivers, or the like (not shown), to allow the device 104 to communicate with other computing devices. In some examples, the communications interface 208 may be enabled with components to support multiple communications protocols, such as Bluetooth Low Energy or other wireless transmissions protocols.

The controller 212 may be a micro-controller, a micro-processor, or other suitable device capable of executing computer-readable instructions to control the components of the communications interface 208 to perform the functionality described herein. The controller 212 may comprise one or more integrated circuits and may include and/or be interconnected with a non-transitory computer-readable storage medium storing computer-readable instructions which when executed configure the controller 212 and/or the communications interface 208 to perform the functionality described herein. In particular, the controller 212 may control the pre-authentication encryption operation of the device 104.

The device 104 may further include one or more input and/or output devices (not shown) suitable to allow an operator to interact with the device 104, such as buttons keypads, touch-sensitive display screens, speakers, and the like.

The access point 112 includes a processor 220, such as a CPU, GPU, microcontroller, series of cooperating processors, ASIC, or the like, interconnected with a non-transitory computer-readable storage medium, such as a memory 224. The memory 224 includes a combination of volatile memory (e.g. RAM) and non-volatile memory (e.g. ROM, EEPROM, flash memory). The processor 220 and the memory 224 may each comprise one or more integrated circuits.

The memory 224 stores computer-readable instructions for execution by the processor 220. In particular, the memory 224 stores an application 228 which, when executed by the processor, configures the processor 220 to perform various functions discussed below in greater detail and related to the pre-authentication encryption operation of the access point 112. The application 228 may also be implemented as a suite of distinct applications.

Those skilled in the art will appreciate that the functionality implemented by the processor 220 may also be implemented by one or more specially designed hardware and firmware components, such as a FPGAs, ASICs and the like in other embodiments. In an embodiment, the processor 220 may be, respectively, a special purpose processor which may be implemented via dedicated logic circuitry of an ASIC, an FPGA, or the like in order to enhance the processing speed of the operations discussed herein.

The access point 112 also includes a communications interface 232 enabling the access point 112 to exchange data with other computing devices such as the device 104. The communications interface 232 is interconnected with the processor 220 and includes suitable hardware (e.g. transmitters, receivers, network interface controllers and the like) allowing the access point 112 to communicate with other computing devices. The specific components of the communications interface 232 are selected based on the type of network or other links that the access point 112 is to communicate over.

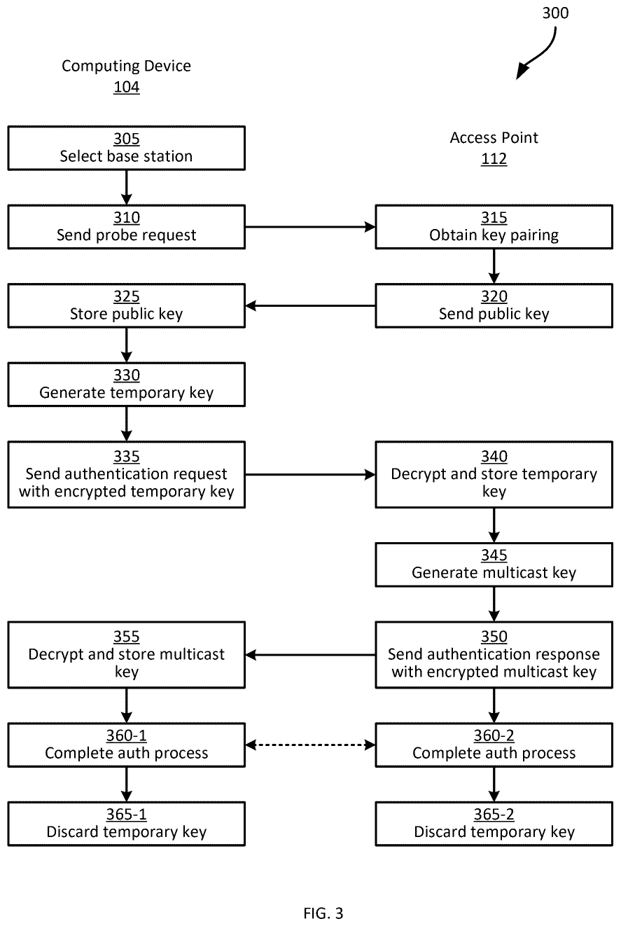

Turning now to FIG. 3, the functionality implemented by the device 104 will be discussed in greater detail. FIG. 3 illustrates a method 300 for pre-authentication encryption. The method 300 will be discussed in conjunction with its performance in the system 100, and particularly between the device 104 and the access point 112, with reference to the components of FIGS. 1 and 2. In other examples, the method 300 may be performed by other suitable devices or systems.

At block 305, the computing device 104 is configured to select a target base station or access point to connect to for access to the network 108. That is, the computing device 104 may select an access point for initiating a communications session, such as a communications session which complies with IEEE 802.11 standards. In particular, the computing device 104 may select the access point 112.

At block 310, the computing device 104 may optionally send a probe request to the target access point 112. In particular, the probe request may include a request for a public key of the access point 112. In other examples, the computing device 104 may proceed directly to block 325, for example if the access point 112 is configured to send periodic beacon signals including the public key, as described below.

At block 315, the access point 112 is configured to obtain a public and private key pairing. In some examples, block 315 may be performed in response to the probe request sent at block 310 by the computing device 104. In other examples, the access point 112 may proactively obtain the public and private key pairing.

The public and private key pairing obtained at block 315 by the access point 112 may be a static predetermined or pre-generated public and private key pairing, for example stored and retrieved in the memory 224. In other examples, the access point 112 may store multiple predetermined or pre-generated public and private key pairings in the memory 224, and the access point 112 may select one of the public and private key pairings, for example on a rotating basis, according to a random selection, or other pseudo-random selection or the like. In still further examples, the access point 112 may generate a new public and private key pairing, for example periodically at predetermined intervals, or in response to the probe request sent by the computing device 104. In examples in which multiple and/or new public and private key pairings are generated, the access point 112 may additionally include an identifier such as an index number or a timestamp for each public and private key pairing to track the appropriate key pairing to use.

At block 320, the access point 112 is configured to send the public key to the computing device 104. In particular, when the access point 112 receives a probe request including a request for the public key, the access point 112 may send a probe response including the public key. In other examples, the access point 112 may send periodic beacon signals including the public key. The access point 112 may additionally send the identifier of the key pairing.

At block 325, the computing device 104 receives and stores the public key of the access point 112.

At block 330, the computing device 104 generates a temporary key for the pre-authentication encryption operation. In particular, the temporary key may be generated for a symmetric encryption operation to be used by the selected access point 112 to encrypt disconnection notifications to allow the computing device 104 to verify the source of the disconnection notifications, and hence the validity of the disconnection notifications. Accordingly, the temporary key may be generated with a sufficient length and/or for use with a sufficiently secure encryption scheme to be resistant to attacks by the malicious device 120 over the length of time for the authentication process to be completed. Since the temporary key is to be used as a session key for the duration of the pre-authentication message exchange and subsequently discarded, the temporary key may be newly generated at each iteration of the method 300, rather than using a pre-generated and stored key. The device 104 may install the temporary key in its radio hardware within the communications interface 208 to decrypt frames encrypted with the temporary key or the device 104 may store the temporary key for example in the memory 204 and employ a software application to apply the temporary key for decryption.

At block 335, the computing device 104 is configured to encrypt the temporary key with the public key of the access point 112 received and stored at block 325. In particular, such encryption ensures that the access point 112 is the only device capable of decrypting and obtaining the temporary key. The computing device 104 may employ a sufficiently secure encryption scheme, such as AES, ChaCha20, CAST, Twofish, or other suitable encryption schemes. Further, to resist man-in-the-middle attacks and to communicate the appropriate encryption scheme, the computing device 104 may include information elements in a predefined order, including the encrypted temporary key, the cipher suite (or an indicator thereof), a random number, and a message integrity check (MIC) value calculated from the other information elements. That is, the computing device 104 may define a message based on the encrypted temporary key, the cipher suite and the random number, generate a MIC value using the public key and the message, and append the MIC value to the message to obtain an encrypted message. The encrypted message may be then included in the authentication request to securely send the temporary key. Other suitable message formats are also contemplated to convey and protect the temporary key. For example, a replay counter may be used instead of a random number to reduce the possibility of a replay attack.

The computing device 104 may then send the encrypted temporary key to the access point 112, as part of an authentication request to initiate the authentication process between the device 104 and the access point 112. That is, the computing device 104 may send an authentication request, including the messages, frames, and information specified, for example in the 802.11w standard, to the access point 112, and may further embed, within the authentication request, the encrypted temporary key. The authentication request may further include the identifier of the key pairing.

At block 340, the access point 112 receives the authentication request from the computing device 104, including the encrypted temporary key. The access point 112 is configured to decrypt and store the temporary key, using the private key corresponding to the public key used for encrypting the temporary key. The access point 112 may similarly install the temporary key in its radio hardware in the communications interface 232 or store the temporary key for example in the memory 224 for use in a software-based decryption application.

At block 345, the access point 112 is configured to generate a multicast key. In particular the temporary key generated by the computing device 104 may be sufficient for unicast communications, in which messages are communicated directly to the computing device 104. The access point 112 may service multiple computing devices (not shown) for connection to the network 108, and in some cases may identify a broad disconnect connection in which all connected computing devices are affected and for which the connection to the access point 112 is to be severed. In such cases, individually sending secure disconnection notifications is inefficient, and hence the access point 112 may broadcast a disconnection notification to all connected computing devices. Such disconnection request may be protected by the multicast key, as will be described further below. Accordingly, the multicast key may similarly be generated with a sufficient length and/or for use with a sufficiently secure encryption scheme to be resistant to attacks by the malicious device 120 over the length of time for the authentication process to be completed. The access point 112 may have one multicast key for connected clients and may have or generate a separate multicast key for clients in the process of connecting to the access point 112. In particular, the access point 112 may discard the multicast key for clients in the process of connecting if no client is attempting to connect and hence may generate a new multicast key when a new client attempts to connect to the access point 112.

At block 350, the access point 112 is configured to encrypt the multicast key with the temporary key received from the computing device 104. The access point 112 may employ the encryption specified with the temporary key, and may similarly include information elements such as the encrypted multicast key, the cipher suite, a random number, and a MIC value to protect the message. The access point 112 may then be configured to send the encrypted multicast key to the computing device 104 as part of an authentication response. That is, the access point 112 may send an authentication response, including the messages, frames and information specified for example in the 802.11w standard, to the computing device 104 and may further embed, within the authentication response, the encrypted multicast key.

More generally, the access point 112 may, at any point prior to completing the authentication process, send a message to the computing device 104 which is encrypted with the temporary key. For example, a relevant payload portion of the message may be encrypted with the temporary key.

At block 355, the computing device 104 receives the authentication response from the access point 112, including the encrypted multicast key. The computing device 104 is configured to decrypt and store the multicast key, using the temporary key used for encrypting the multicast key. More generally, prior to completing the authentication process, the computing device 104 may receive another message (e.g., including the authentication response or authentication messages as part of the authentication process, or other relevant messages occurring prior to completion of the authentication process) which is encrypted with the temporary key. The computing device 104 may decrypt the message using the temporary key to validate the access point 112 as the source of the message.

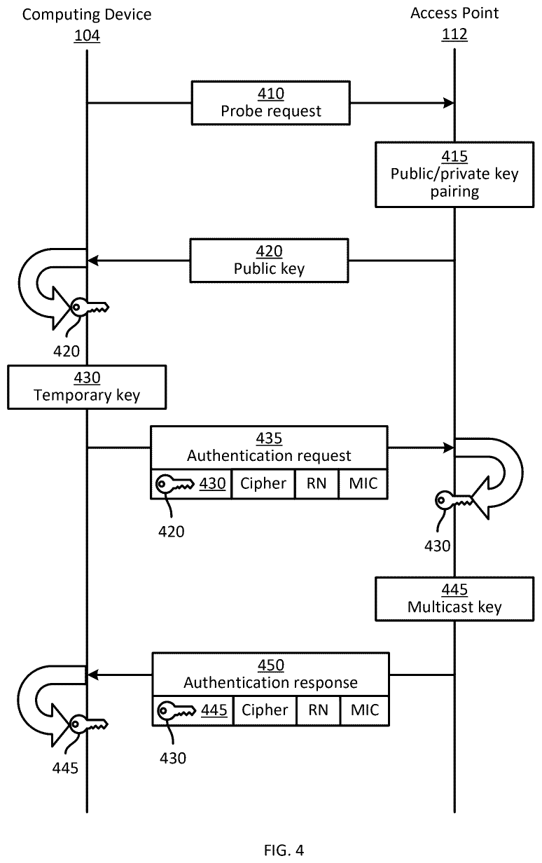

For example, FIG. 4 is a schematic diagram illustrating the communication flow during blocks 310 to 350 of the method 300. In particular, in response to selecting the access point 112 to connect to, the computing device 104 may optionally send a probe request 410 to the access point 112. The access point 112 may generate or otherwise obtain a public and private key pairing 415, for example in response to the probe request 410, or in response to another key generation condition (e.g., passage of a predetermined time interval or the like). The access point 112 may then send a public key 420 from the key pairing 415 to the computing device 104. For example, the public key 420 may be broadcast in a beacon signal which may be received by the computing device 104 or optionally may be embedded in a probe response sent in reply to the probe request 410. Upon receiving the public key 420, the computing device 104 may store the public key 420 for use.

The computing device 104 may then generate a temporary key 430 for use in the pre-authentication encryption operation. The computing device 104 may encrypt the temporary key 430 using the public key 420. The computing device 104 may then send an authentication request 435 to the access point 112 to initiate an authentication process between the computing device 104 and the access point 112. The authentication request 435 may further include, for example embedded as an additional message or frame in or appended to the request, the temporary key 430 as encrypted by the public key 420. Further, the authentication request 435 may include a cipher suite indicating the type(s) of cryptographic schemes expected to be used with the temporary key 430, a random number (RN), and a MIC value computed based on the encrypted temporary key 430, the cipher suite and the random number. In particular, the MIC value may allow for verification of the authenticity and/or originality of the message (i.e., to verify that none of the information elements from which the MIC was generated have been tampered with).

In response to receiving the authentication request 435, including the encrypted temporary key 430, the access point 112 may store or install the temporary key 430 for pre-authentication encryption. In particular, the access point 112 may use the private key from the key pairing 415 to decrypt the encrypted temporary key 430. The access point 112 may additionally generate or retrieve a multicast key 445 for multicast pre-authentication communications. The access point 112 may encrypt the multicast key using the temporary key 430 received from the computing device 104 for pre-authentication encryption. The access point 112 may then send an authentication response 450 to the computing device 104 to acknowledge the authentication request 435 and to provide the computing device 104 with the information and/or data to proceed with the authentication process. The authentication response 450 further includes the multicast key 445 as encrypted by the temporary key 430, and may additionally include the cipher suite, a random number, and a MIC value computed based on the aforementioned elements.

In response to receiving the authentication response 450 including the encrypted multicast key 445, the computing device 104 may decrypt the encrypted multicast key 445 using the temporary key 430 and may store or install the multicast key 445.

Accordingly, after securely exchanging the temporary key 430 and the multicast key 445, both the computing device 104 and the access point 112 may have these keys stored, and hence disconnection notifications or messages may be securely sent, for example similarly to the 802.11w standard, to allow the computing device 104 to validate the source of such requests and therefore protect against DOS attacks. In particular, the access point 112 may encrypt disconnection notifications sent directly to the computing device 104 with the temporary key 430 as a unicast message. The access point 112 may encrypt disconnection notifications broadcast to all connected (or connecting) devices, including the computing device 104 with the multicast key 445.

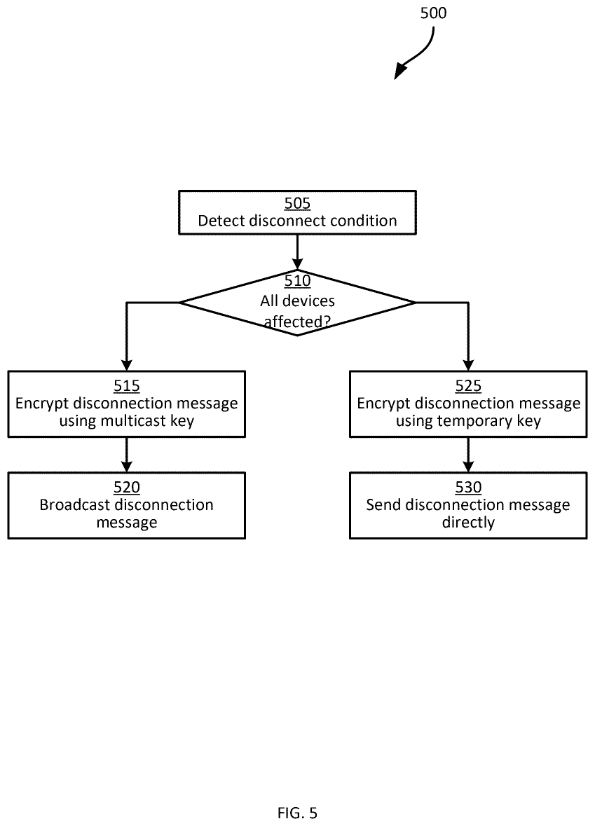

For example, referring to FIG. 5, a flowchart of an example method 500 of sending a disconnect request with pre-authentication encryption by an access point is depicted. The method 500 will be described in conjunction with its performance by the access point 112 in the system 100; in other examples, the method 500 may be performed by other suitable devices or systems.

At block 505, the access point 112 detects a disconnect condition, such as connectivity or interference issues, between the access point 112 and one or more of the individually connected devices, or between the access point 112 and the network 108, setting, configuration or device issues with the access point 112 itself, or other conditions.

At block 510, the access point 112 determines whether the disconnect condition affects all the devices connected or connecting to the access point 112, or whether the disconnect condition is specific to a single or subset of devices, such as the computing device 104.

If the determination at block 510 is that the disconnect condition affects multiple devices, then the access point 112 proceeds to block 515. At block 515, the access point 112 retrieves the multicast key communicated to each of the devices connected or connecting to the access point 112 and encrypts a disconnection notification using the multicast key. For example, the access point 112 may use the disconnection notification and the multicast key to generate a MIC value and append the MIC value to the disconnection notification to generate the encrypted disconnection notification.

At block 520, the access point 112 broadcasts the encrypted disconnection notification, for example in a beacon signal or the like. In particular, the disconnection notification is sent as a single multicast message to communicate to each of the devices connected or connecting to the access point 112 and instruct the devices to disconnect from the access point 112. Further, since the disconnection notification is encrypted with the multicast key, each of the client or endpoint devices may verify the access point 112 as the source of the disconnection notification using the multicast key.

If the determination at block 510 is that the disconnect condition affects a single device or a subset of devices connected, then the access point 112 proceeds to block 525. At block 525, the access point 112 is configured to generate a disconnection notification configured as a unicast message to be sent directly to each of the affected devices, such as the device 104. For devices which are authenticated with the access point 112, the access point 112 may encrypt and send the disconnection notification using the same procedure as the 802.11w standard. For devices which are not yet authenticated with the access point 112, the access point 112 obtains the temporary key generated by and received from the given device. The access point 112 may then encrypt the disconnection notification using the temporary key. For example, the access point 112 may use the disconnection notification and the temporary key to generate a MIC value and append the MIC value to the disconnection notification to generate the encrypted disconnection notification.

At block 530, the access point 112 sends the encrypted disconnection notification directly as a unicast message to the given device. Since the disconnection notification is encrypted with the temporary key for the device, the device may verify the access point 112 as the source of the disconnection notification using the temporary key, even though the device has not yet completed the authentication with the access point 112.

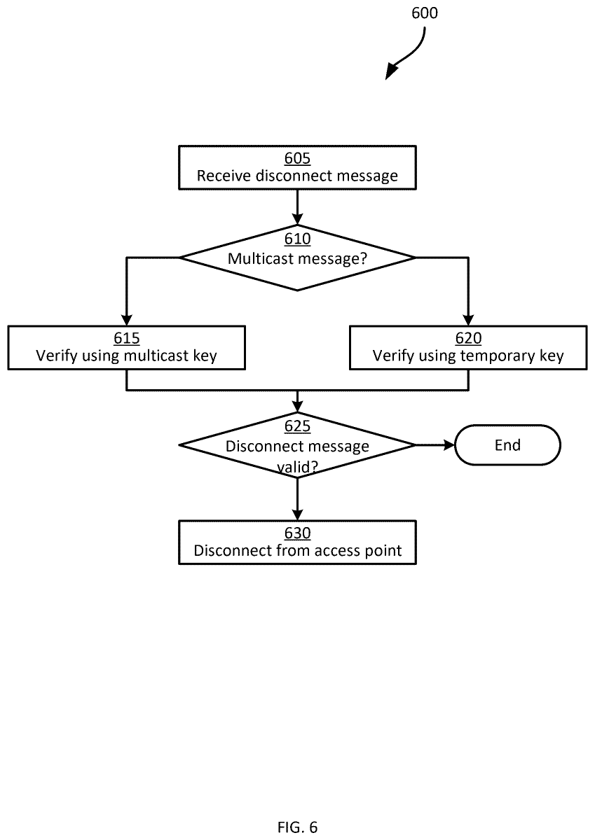

In particular, referring to FIG. 6, a flowchart of an example method 600 of validating a disconnection notification is depicted. The method 600 will be discussed in conjunction with its performance by the device 104; in other examples the method 600 may be performed by other suitable devices.

At block 605, the device 104 receives a disconnection notification requesting that the device 104 disconnects (e.g., disassociates or deauthenticates) from the access point 112.

At block 610, the device 104 determines whether the disconnection notification is a multicast message.

If the device 104 determines at block 610 that the disconnection notification is a multicast message, then the device 104 proceeds to block 615. At block 615, the device 104 validates the disconnection notification using the multicast key received from the access point 112. For example, the device 104 may use the disconnection notification and the multicast key to compute a MIC value and determine whether the MIC value from the encrypted disconnection notification
matches the computed MIC value. In particular, without the multicast key, the malicious device may not be able to generate a suitable MIC value.

If the device 104 determines at block 610 that the disconnection notification is a unicast message, then the device 104 proceeds to block 620. At block 620, the device 104 validates the disconnection notification using the temporary key generated by the device 104 and sent to the access point 112. For example, the device 104 may similarly use the disconnection notification and the temporary key to compute a MIC value and determine whether the MIC value from the encrypted disconnection notification matches the computed MIC value. In particular, without the temporary key, the malicious device may not be able to generate a suitable MIC value.

At block 625, the device 104 determines whether the disconnection notification is valid. For example, the device 104 may make the determination based on whether the computed MIC value matches the MIC value from the encrypted disconnection notification. In other examples, the multicast or temporary keys may be used in other contemplated manners to verify the source of the disconnection notification and thereby validate the disconnection notification.

If the determination at block 625 is affirmative, that is, the MIC values match or the disconnection notification is otherwise determined to be valid, then the device 104 proceeds to block 630. At block 630, the device 104 disconnects from the access point 112.

If the determination at block 625 is negative, that is, the MIC values do not match, or the disconnection notification is otherwise determined to be invalid, then the method 600 ends. In particular, the device 104 may determine that the disconnection notification was not sent by the access point 112 and hence may be an attack or the like, and accordingly may take no action.

Returning to FIG. 3, at blocks 360-1 and 360-2, in response to receiving and sending the authentication response, respectively, the computing device 104 and the access point 112 are configured to complete the authentication process. For example, the authentication process may include installation of one or more additional keys for encryption during the authenticated communications, and which may be communicated in accordance with a predetermined sharing and/or standards method, such as the 802.11w standard. This may include key derivation and key installation, association, 802.1x authentication, extensible authentication protocol over LAN (EAPOL) exchanges, or the like.

At blocks 365-1 and 365-2, in response to completing the authentication process, the computing device 104 and the access point 112, respectively, are configured to discard the temporary key. In particular, the authentication process may define other keys or other manners of securely communicating between the computing device 104 and the access point 112, and hence the temporary key is no longer needed for encryption of messages.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method comprising:
selecting an access point to initiate a communications session;
obtaining a public key of the access point;
generating a temporary key for pre-authentication encryption;
encrypting the temporary key with the public key of the access point;
sending an authentication request to the access point to initiate an authentication process with the access point, the authentication request including the encrypted temporary key;
completing the authentication process to begin authenticated communications with the access point; and
discarding the temporary key.

2. The method of claim 1, further comprising:
prior to completing the authentication process, receiving a message from the access point, the message encrypted with the temporary key; and
decrypting the message using the temporary key to validate the access point as a source of the message.

3. The method of claim 1, further comprising:
prior to completing the authentication process, receiving a disconnection request;
validating the disconnection request using the temporary key;
disconnecting from the access point when the disconnection request is valid; and
discarding the disconnection request when the disconnection request is invalid.

4. The method of claim 1, further comprising:
defining a message using the encrypted temporary key, a cipher suite indicator, and a random number;
generating a message integrity check value using the public key and the message;
appending the message integrity check value to the message to obtain an encrypted message; and
including the encrypted message in the authentication request.

5. The method of claim 1, further comprising:
receiving an authentication response from the access point, the authentication response including an encrypted multicast key;
decrypting the multicast key using the temporary key; and
storing the multicast key.

6. The method of claim 5, further comprising:
prior to completing the authentication process, receiving a multicast disconnection request;
validating the multicast disconnection request using the multicast key;
disconnecting from the access point when the multicast disconnection request is valid; and
discarding the multicast disconnection request when the multicast disconnection request is invalid.

7. The method of claim 1, wherein obtaining the public key comprises:
sending a probe request to the access point; and
receiving a probe response including the public key of the access point.

8. The method of claim 1, wherein the communications session complies with IEEE 802.11 standards.

9. A method at an access point, the method comprising:
obtaining a public key and a private key corresponding to the public key for the access point;
receiving an authentication request from an computing device to initiate an authentication process, the authentication request including an encrypted temporary key for pre-authentication encryption;
decrypting and storing the temporary key using the private key;
completing the authentication process to begin authenticated communications with the computing device; and
discarding the temporary key.

10. The method of claim 9, further comprising:
receiving a probe request from the computing device; and
in response to the probe request, sending the public key to the computing device as a probe response.

11. The method of claim 9, further comprising:
generating a plurality of public and private key pairings; and
selecting one of the public and private key pairings as the public and private key.

12. The method of claim 9, further comprising:
obtaining a multicast key for multicast communications;
encrypting the multicast key using the temporary key; and
sending the encrypted multicast key in an authentication response to the computing device.

13. The method of claim 9, further comprising:
detecting a disconnect condition;
encrypting a disconnection request with one of the temporary key and a multicast key; and
sending the encrypted disconnection request to the computing device.

14. The method of claim 9, further comprising: prior to completing the authentication process, sending a message to the computing device, the message encrypted with the temporary key.

15. The method of claim 9, wherein communications between the access point and the computing device comply with IEEE 802.11 standards.

16. A computing device comprising:
a communications interface;
a controller interconnected with the communications interface, the controller configured to:
select an access point to initiate a communications session;
obtain a public key of the access point;
generate a temporary key for pre-authentication encryption;
encrypt the temporary key with the public key of the access point;
send an authentication request to the access point to initiate an authentication process with the access point, the authentication request including the encrypted temporary key;
complete the authentication process to begin authenticated communications with the access point; and
discard the temporary key.

17. The computing device of claim 16, wherein the controller is further configured to:
prior to completing the authentication process, receive a message from the access point, the message encrypted with the temporary key; and
decrypt the message using the temporary key to validate the access point as a source of the message.

18. The computing device of claim 16, wherein the controller is further configured to:
prior to completing the authentication process, receive a disconnection request;
validate the disconnection request using the temporary key;
disconnect from the access point when the disconnection request is valid; and
discard the disconnection request when the disconnection request is invalid.

19. The computing device of claim 16, wherein the controller is further configured to:
define a message using the encrypted temporary key, a cipher suite indicator, and a random number;
generate a message integrity check value using the public key and the message;
append the message integrity check value to the message to obtain an encrypted message; and
include the encrypted message in the authentication request.

20. The computing device of claim 16, wherein the controller is further configured to:
receive an authentication response from the access point, the authentication response including an encrypted multicast key;
decrypt the multicast key using the temporary key; and
store the multicast key.

21. The computing device of claim 20, wherein the controller is further configured to:
prior to completing the authentication process, receive a multicast disconnection request;
validate the multicast disconnection request using the multicast key;
disconnect from the access point when the multicast disconnection request is valid; and
discard the multicast disconnection request when the multicast disconnection request is invalid.

22. The computing device of claim 16, wherein to obtain the public key, the controller is configured to:
send a probe request to the access point; and
receive a probe response including the public key of the access point.

23. The computing device of claim 16, wherein the communications session complies with IEEE 802.11 standards.

24. An access point comprising:
a communications interface; and
a processor interconnected with the communications interface, the processor configured to:
obtain a public key and a private key corresponding to the public key for the access point;
receive an authentication request from a computing device to initiate an authentication process, the authentication request including an encrypted temporary key for pre-authentication encryption;
decrypt and store the temporary key using the private key;
complete the authentication process to begin authenticated communications with the computing device; and
discard the temporary key.

25. The access point of claim 24, wherein the processor is further configured to:
receive a probe request from the computing device; and
in response to the probe request, send the public key to the computing device as a probe response.

26. The access point of claim 24, wherein the processor is further configured to:
generate a plurality of public and private key pairings; and
select one of the public and private key pairings as the public and private key.

27. The access point of claim 24, wherein the processor is further configured to:
obtain a multicast key for multicast communications;
encrypt the multicast key using the temporary key; and
send the encrypted multicast key in an authentication response to the computing device.

28. The access point of claim 24, wherein the processor is further configured to:
detect a disconnect condition;
encrypt a disconnection request with one of the temporary key and a multicast key; and
send the encrypted disconnection request to the computing device.

29. The access point of claim 24, wherein the processor is further configured to: prior to completing the authentication process, send a message to the computing device, the message encrypted with the temporary key.

30. The access point of claim 24, wherein communications between the access point and the computing device comply with IEEE 802.11 standards.
